(19) United States
(12) Patent Application Publication
(10) Pub. No.: US 2023/0144717 A1
(43) Pub. Date: May 11, 2023

(54) Display Support System And Methods Of Use Thereof

(71) Applicant: Balloon Innovations Inc., Westminster, CO (US)

(72) Inventors: Christopher Jon Wicken, JR., Westminster, CO (US); Alex John Fountain, Evergreen, CO (US)

(21) Appl. No.: 17/973,251

(22) Filed: Oct. 25, 2022

Related U.S. Application Data
(60) Provisional application No. 63/276,355, filed on Nov. 5, 2021.

(51) Int. Cl. G06F 1/16; F21S 4/10

(52) U.S. Cl. CPC G06F 1/1607; F21S 4/10

(57) ABSTRACT

The inventive technology relates to an display support system that may be used to support elevated displays, such as marketing materials and lighting displays.

### CROSS-REFERENCE TO RELATED APPLICATIONS

This application claims the benefit of and priority to U.S. Provisional Application No. 63/276,355, filed Nov. 5, 2021. The entire specification and figures of the above-referenced application are hereby incorporated, in their entirety by reference.

### TECHNICAL FIELD

Generally, the inventive technology relates to an improved display support system configured to secure advertisements or lighting displays at elevated positions. More specifically, the inventive technology described generally herein relates to an improved display support system that may be used to install displays having one or more display cords, such as traditional Christmas lighting strings, to elevated external surfaces.

### BACKGROUND

Traditional marketing and lighting displays are often placed in elevated positions to both generate a clear line of sight, as well as to make use of generally empty space thus maximizing the display's visual impact. Such traditional displays, such as signage, flags, balloons, lighting, and even artistic presentations are often secured in elevated positions through simple string based systems. The simplest, and most universal example would be installation of a string of external lights to decorate one's home or other external location. While such configuration is simple, it possesses several practical drawbacks. First, attachment of such traditional lighting systems to an elevated external surface, such as the outside of one's home or work, may be difficult and even dangerous. In a typical scenario a person would have to bring themselves up to the desired elevation, such as by a ladder or other means, which can be dangerous and often impractical. Second, in many cases the elevated surface may not have sufficient positions to secure a traditional lighting display. Such examples may include sheer surfaces with no positions that could be used as a tie-off, hook or other support. Third, in many cases, the weight of the display may make it prohibitively heavy to secure through traditional means.

To overcome such limitations, several attempts have been made to utilize magnetic anchors to secure traditional displays in elevated locations. However, these attempts to position advertising, marketing and even artistic displays in elevated locations have been met with limited success. For example, U.S. Pat. No. 6,422,622 (hereinafter “Bernard”), describes a magnetic installation and removal device having a magnetic anchor secured to a lug which can be further secured to, for example, a string attached to a display, then elevated to a desired location. However, the configuration in Bernard is limited in several significant ways. First, the placement of the magnetic anchor by balancing it on top of a lug and securing it though the placement of a ring over an extended cylindrical element is inefficient and unstable. Such instability is undesirable as a user would be, due to the vertical configuration of the anchor and lug, positioned directly below the unstable anchor. Second, the lug element is not adjustable, making it impossible to magnetically engage an anchor to non-perpendicular, or other angled surfaces. Third, the inability to adjust the lug and anchor portions further makes it very difficult to position the spiral extension to capture a secured anchor that is in a non-perpendicular position. Fourth, spiral extension does not possess a locking mechanism such that during removal of a secured anchor, it may become dislodged and endanger anyone who might be below, not to mention damaging the display itself.

As can be seen, there is a need for a single comprehensive solution to the limitations of traditional display support systems, and in particular lighting display supports described above.

### SUMMARY OF THE INVENTION

Aspects of the present invention includes a display support system configured to attach and detach one or more displays to an external surface. In one preferred embodiment, a display support system is configured to attach and detach one or more lighting displays having a series of lights positioned along a display cord to an external surface, such as the outside trim or gutter of a user's home or work. Notably, the display support system of the invention may be configured to secure and remove a variety of displays, and preferably displays or components a user's may wish to secure to an external surface, and more preferably displays that include at least one display cord, such as an advertising display, a lighting display as noted above, a rope, display cord, a sign, a banner, a flag, and a balloon display, or a combination of the same.

Additional aspects of the present invention will become apparent through the detailed explanation below.

### BRIEF DESCRIPTION OF THE FIGURES

FIG. 1A-C: (A) show a side perspective view of a pivot support coupled with an extended arm in one embodiment thereof; (B) show a side perspective view of an installer having a catch in one embodiment thereof; (C) shows a side perspective view of a pivot support coupled with an installer through a magnetic coupler in one embodiment thereof;

FIG. 2A-E: (A) shows a side view of a pivot support coupled with an extended arm coupled with an installer through a magnetic coupler in one embodiment thereof, (B) shows a side view of a pivot support coupled with an installer through a magnetic coupler having a catch in one embodiment thereof, (C) shows a side view of a pivot support coupled with an installer having a catch through a magnetic coupler, and an adaptor plate secured to the body of the support base in one embodiment thereof, (D) shows a bottom view of a pivot support coupled with an installer having a catch through a magnetic coupler, and an adaptor plate secured to the body of the support base in one embodiment thereof, (E) shows a side perspective view of a pivot support coupled with an installer having a catch through a magnetic coupler, and an adaptor plate secured to the body of the support base in one embodiment thereof,

FIG. 3A-C: (A) is an isolated perspective view of a catch having a catch opening and a rotational coupler in one embodiment thereof, (B) is an isolated perspective view of a catch having a catch opening with a catch channel having a ridged surface in one embodiment thereof, (C) is an isolated perspective view of a catch having a catch opening and a rotational coupler in one embodiment thereof,

FIG. 4A-D: (A) is an isolated perspective view of an installer having a detachable coupler position in one embodiment thereof; (B) is an isolated perspective view of an installer having a pole aperture in one embodiment thereof, (C) is an isolated perspective view of an installer having a detachable coupler position with a plurality of grooves and notches in one embodiment thereof; (D) is an isolated perspective view of an installer having an latch configured to secure the channel of a pivot support in one embodiment thereof

FIG. 5A-B: (A) is an isolated perspective view of a pivot support having a rotation slot and attachment surface in one embodiment thereof, (B) is an isolated perspective view of a pivot support having a display insert having a series of grooves and notches in one embodiment thereof,

FIG. 6A-B: (A) is an isolated perspective view of an adhesive adaptor plate in one embodiment thereof; (B) is an isolated perspective view of a magnetic adaptor plate having a plurality of fastener positions in one embodiment thereof;

FIG. 7A-B: (A) shows a method of securing a display cord in the catch of an extended arm further rotatably secured to a pivot support in one embodiment thereof, (B) shows a pivot support rotatably adjusting in relation to the extended arm and display cord to as to remain in an approximately vertical orientation relative to the assembly components in one embodiment thereof;

FIG. 8A-C: (A) shows a method of display support system assembly coupled with a pole in one embodiment thereof, (B) shows a method of securing a display cord to a series of adaptor plates secured to an external surface in one embodiment thereof; (C) shows an installed having a latch secured to the channel portion of a pivot support during removal of the support from an adaptor plate in one embodiment thereof.

FIG. 9A-D: (A) shows an adaptor plate that can be secured in series to an external surface in one embodiment thereof; (B) shows a plurality of fasteners that can secure an adaptor plate to an external surface in one embodiment thereof and shows an adaptor plate that can be secured to an external surface through an adhesive attachment in one embodiment thereof, (C) shows a pivot support secured to the pocket of an adaptor plate in one embodiment thereof, (D) shows a pivot support secured to an external surface in one embodiment thereof.

### DETAILED DESCRIPTION OF THE INVENTION

The present invention includes a variety of aspects, which may be combined in different ways. The following descriptions are provided to list elements and describe some of the embodiments of the present invention. These elements are listed with initial embodiments; however, it should be understood that they may be combined in any manner and in any number to create additional embodiments. The variously described examples and preferred embodiments should not be construed to limit the present invention to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

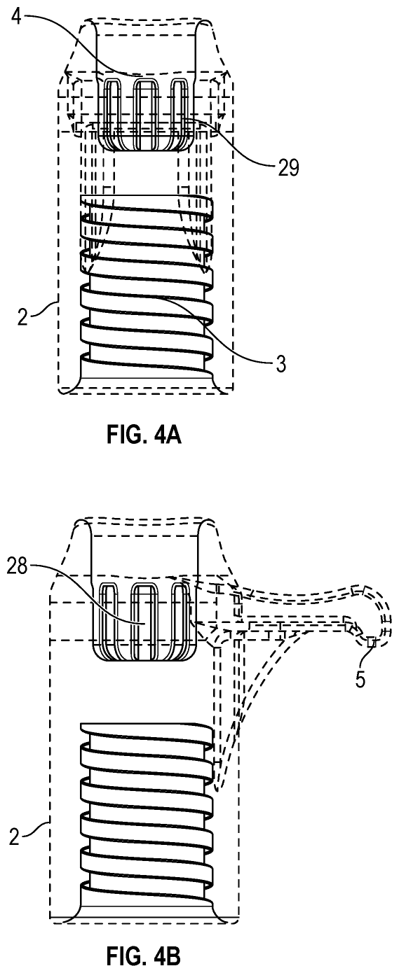

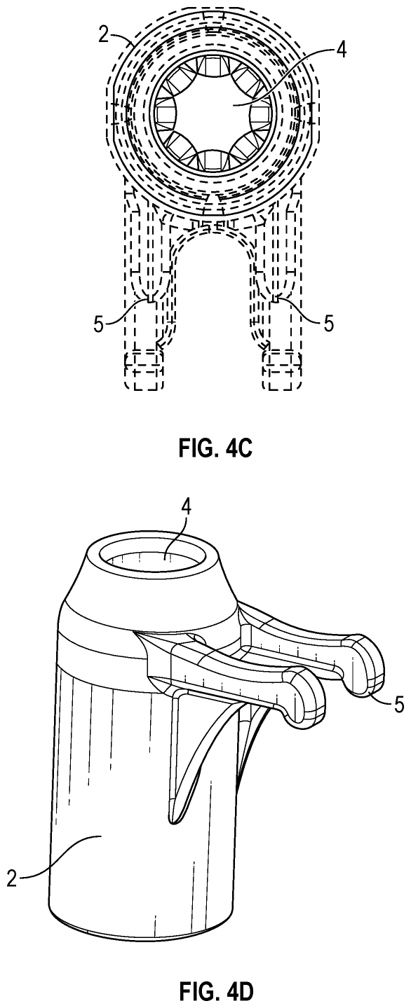

A display support system (1) of the invention may include an installer (2). Generally referring to FIG. 4A-D, the installer (2) of the invention may include a cylindrical housing having two terminal ends. In some embodiment the installer (2) of the invention may be a unitary component, while in other embodiments it may include separable components. At one terminal end, the installer (2) may include a pole aperture (3) configured to secure a pole (27). As shown in the figures, in a preferred embodiment, the pole aperture (3) of the installer (2) may include a threaded position that may be mated with a threaded position on a corresponding pole (27) forming a threaded coupler position.

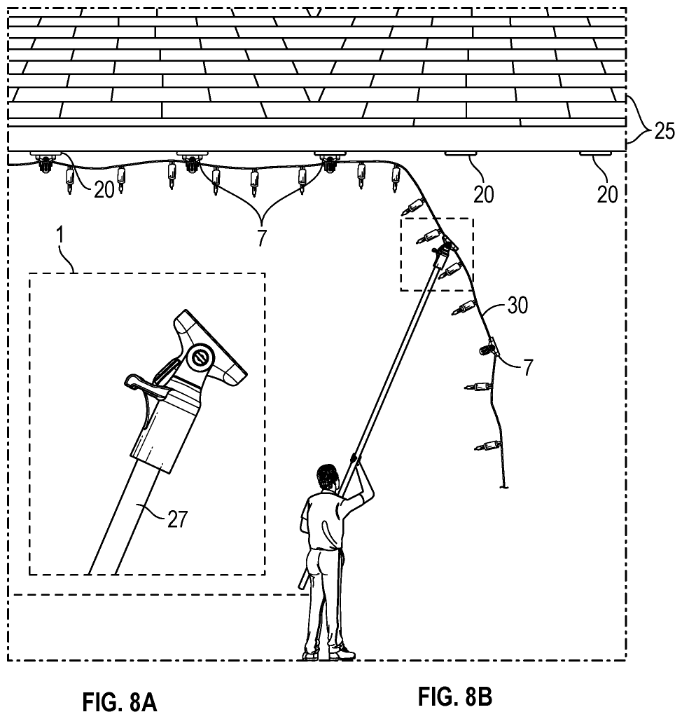

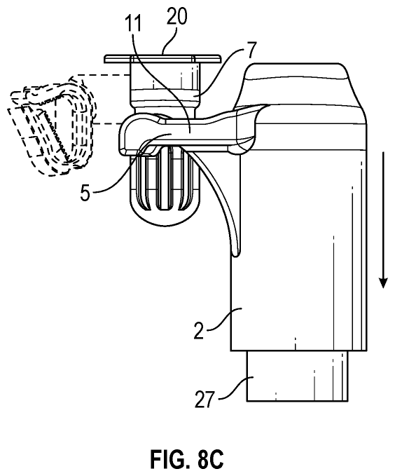

Naturally, this embodiment is exemplary only, as a pole (27) may be secured to the pole aperture (3) of the installer (2) through a number of different coupler configurations, such as a snap coupler, slide coupler, twist coupler, quick release coupler, compression coupler, fitted coupler, or a spring-loaded coupler and the like. As noted in FIG. 8B, a pole (27) of the invention may be a single unitary pole (27) or may be formed by a series of coupled pole segments, wherein in both embodiments the pole is sufficiently long to reach an elevated or other external surface (25) as described below.

As shown in FIGS. 4A-D, the installer (2) of the invention may include a detachable coupler position (4) positioned at the terminal end opposing the pole aperture (3). In this embodiment, the detachable coupler position (4) may include an aperture configured to be mated with a pivot support (7) as described below. In a preferred embodiment, the pivot support (7) may be coupled with the installer (2) through the detachable coupler position (4) through a detachable coupler, including, but not limited to: such as a snap coupler, slide coupler, twist coupler, quick release coupler, compression coupler, fitted coupler, or a spring-loaded coupler and the like.

In a preferred embodiment, the pivot support (7) may be coupled with the installer (2) through the detachable coupler position (4) through a detachable coupler, which may include a magnetic coupler. In one embodiment, a detachable coupler means a system, methods and devices that allow the detachable coupling of the pivot support (7) and the installer (2) that exhibit less attachment force than the coupling force generated by the attachment of the attachment surface (12) of the pivot support (7) to an adaptor plate (20) or external surface (25) generally. This may be done by a fitted coupled, or a magnetic coupler. A detachable coupler may include a system, methods and devices that allow the detachable coupling of the pivot support (7) and the installer (2) that can be manually disengaged by a user without braking the attachment surface (12) of the pivot support (7) to an adaptor plate (20) or external surface (25) generally.

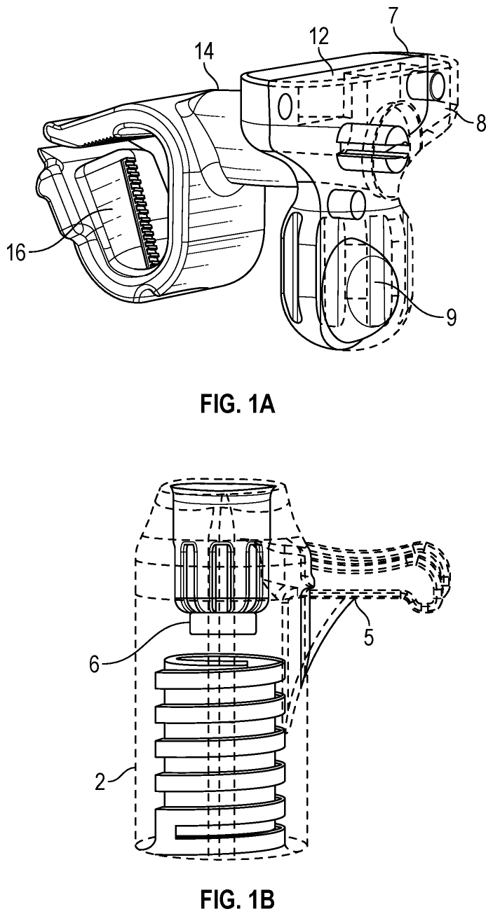

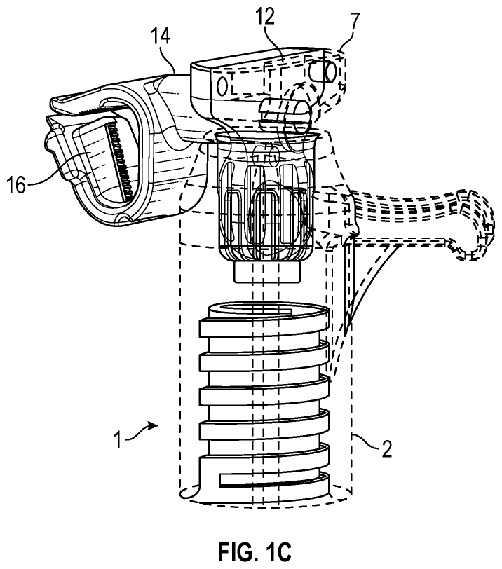

In this embodiment, a pivot support (7) may be magnetically coupled with the installer (2) through the detachable coupler position (4). As shown in FIG. 1B-C, a magnet (6) may be positioned within the detachable coupler position (4) such that when it is secured to a pivot support (7) a corresponding metal coupler (9) is placed adjacent to the magnet (6) such that the two are responsive to one another and form a magnetic coupling securing the installer (2) and pivot support (7). In alternative embodiments, a magnet (6) may be positioned within the pivot support (7) such that when it is secured to a detachable coupler position (4), a corresponding metal coupler (9) is placed adjacent to the magnet (6) such that the two are responsive to one another and form a magnetic coupling securing the installer (2) and pivot support (7).

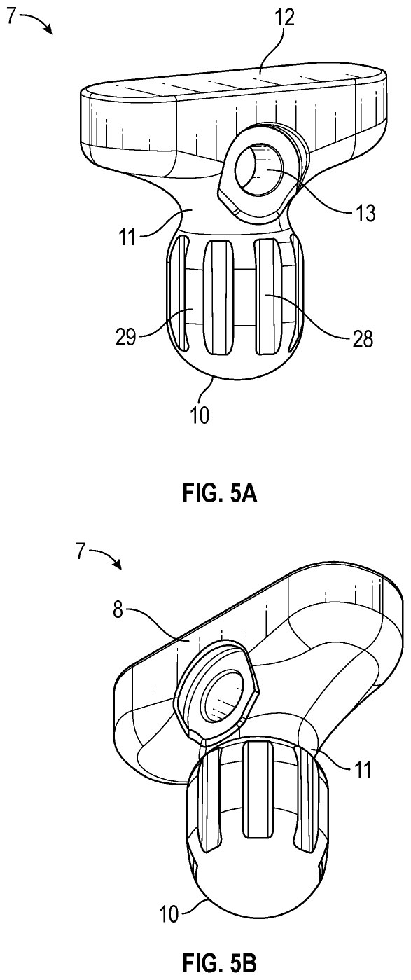

The display support system (1) of the invention may include a pivot support (7) configured to be coupled with the installer (2) as generally described above. In some embodiment the pivot support (7) of the invention may be a unitary component, while in other embodiments it may include separable components. Referring to FIGS. 5A-B, in a preferred embodiment, a pivot support (7) may include a support base (8) having a rotational slot (13). As described below, the rotational slot (13) may include a coupler position configured to be coupled with an extended arm (14) such that the pivot support (7) may be independently rotatable in relation to the extended arm (14).

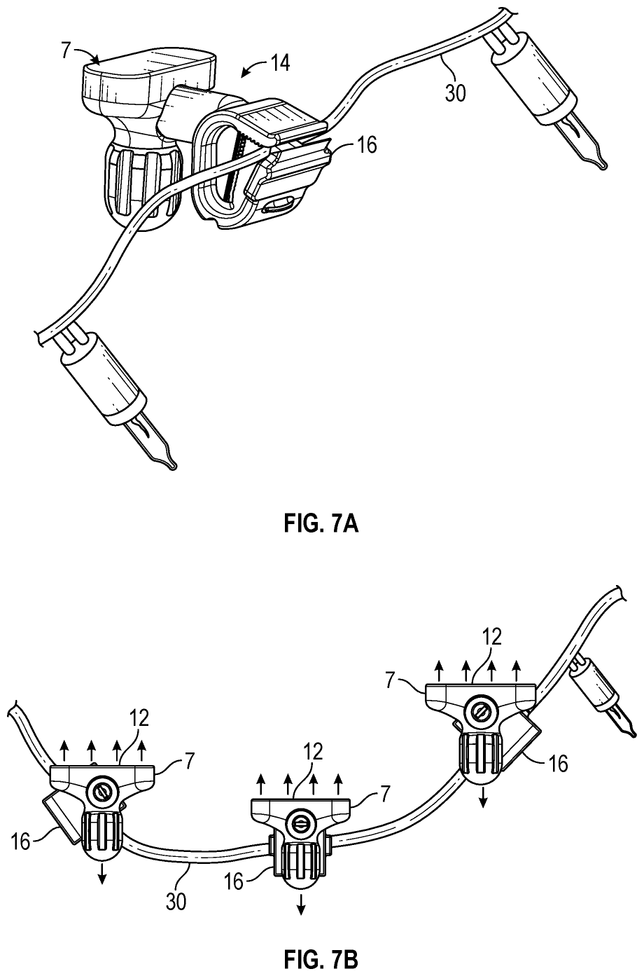

As generally described above, the pivot support (7) of the invention may include a display insert (10) configured to be detachably coupled within the detachable coupler (4) of the installer (2). In a preferred embodiment shown in FIG. 1 generally, a metal coupler (9) may be positioned within the display insert (10) such that when it is inserted into the detachable coupler (4) of the installer (2) the metal coupler (9) is placed adjacent to a magnet (6) such that the two are responsive to one another and form a magnetic coupling securing the installer (2) and pivot support (7). Notably, in this preferred embodiment, the metal coupler (9) may be sufficiently sized such that the pivot support (7) of the invention may be weighted. In this configuration, as shown in FIG. 7B, the weight of the metal coupler, or other weight may allow the sufficient gravitational force to be applied to the bottom terminal end of the pivot support (7) such that the pivot support (7) is maintained in an approximately upright position with respect to the extended clip (14) and/or a display cord (30).

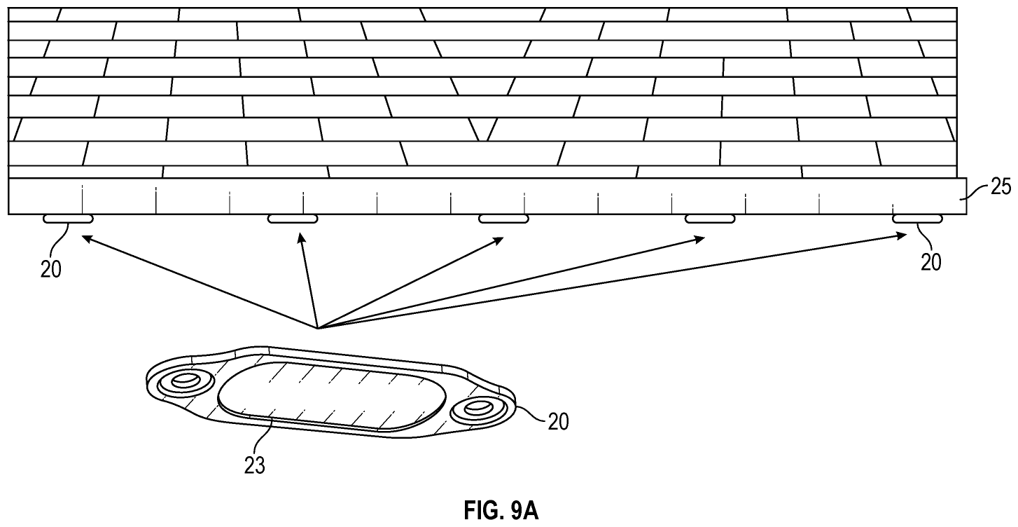

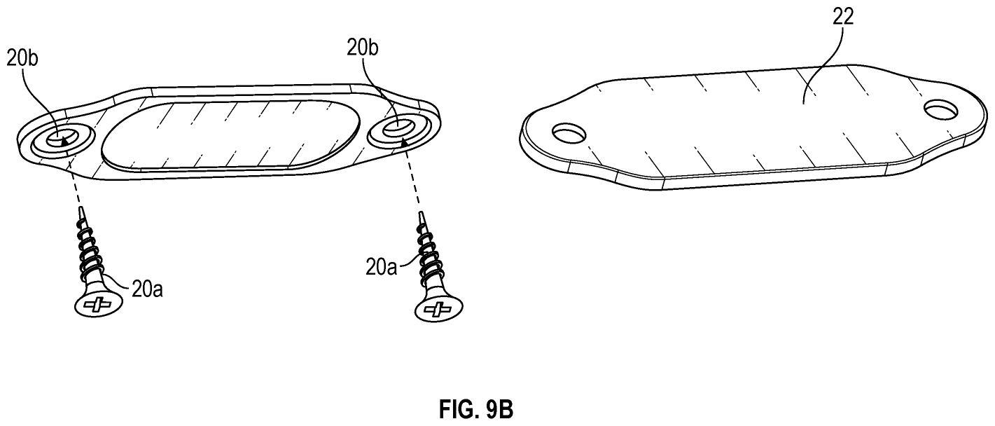

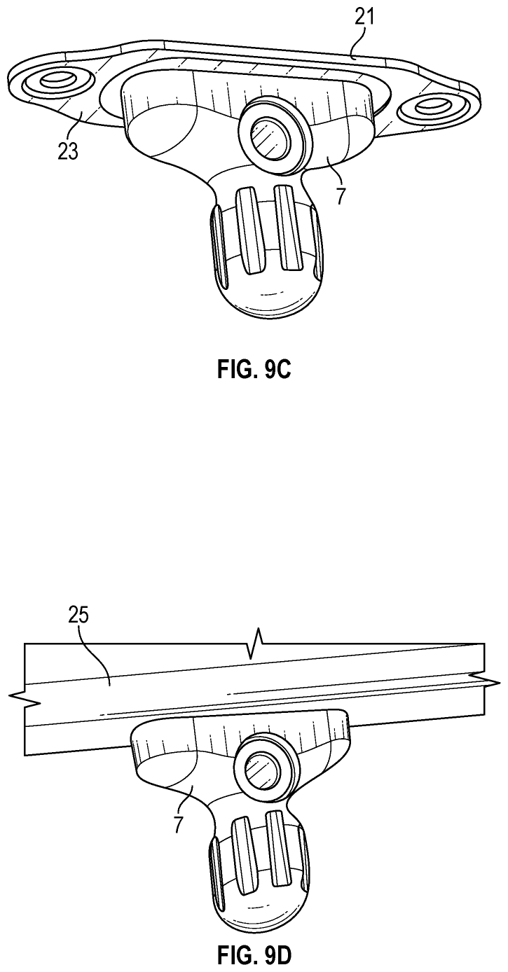

The pivot support (7) of the invention may include a support base (8) having an attachment surface (12) which may include a substantially planar surface that may be configured to be coupled directly to an external surface (25) or to an adaptor plate. For example, in the preferred embodiment shown in FIG. 9D, the attachment surface (12) of the invention may include a magnetic attachment surface (12), or an adhesive attachment surface (12) such that it may be directly coupled to an external surface (25), such as the external trim of building, or even a metal gutter and the like. In a preferred embodiment, a magnet may be positioned internally or externally on the attachment surface, while in still further embodiments there the attachment surface (12) of the invention may be an adhesive, such as a layer of VHB adhesive, or one or more magnets.

The pivot support (7) of the invention may include a channel (11). In the preferred embodiment a channel (11) of the invention may include a shaped portion of the pivot support (7) configured to be mated with a latch (5) on the installer (2) to facilitate detachment of the pivot support (7) from an adaptor plate (20) or external surface (25). In the embodiment shown in FIG. 5A, a channel (11) of the invention a tapered portion positioned above the display insert (10). As further shown in FIG. 8C, a latch, having a pair of extended arms, may be coupled with the channel (2). When a downward force is applied the latch (5) engages with the flared terminal portion of the channel such that the pivot support (7) is detached from the from an adaptor plate (20) or external surface (25).

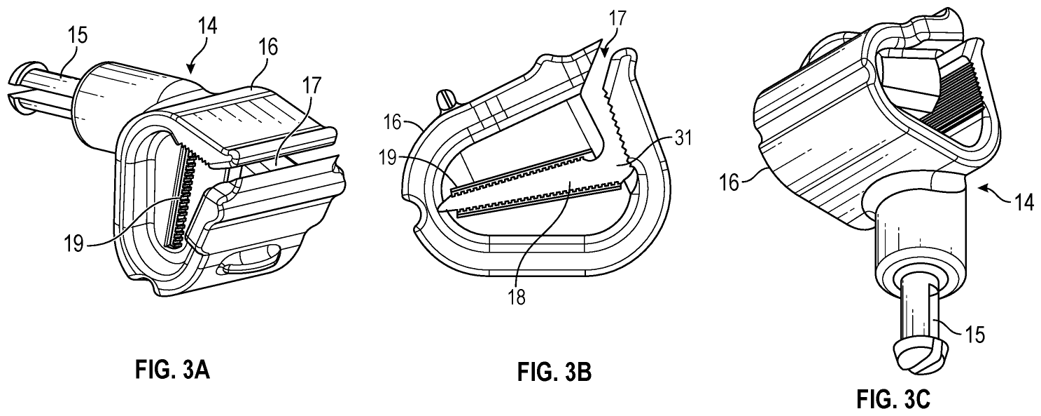

The display support system (1) of the invention may include an extended arm (14), which may be configured to be coupled with the pivot support (7), and preferably rotatably coupled. In the preferred embodiment shown in FIG. 3A, an extended arm (14) may include a rotational coupler (15) configured to be rotatably coupled with rotational slot (13) on the pivot support (7). As noted above, the pivot support (7) may be weighted so that it is remaining in a substantially vertical position relative to the extended arm (140 which may freely rotate in relation to the pivot support (7). In a preferred embodiment, the rotational coupler (15) of the invention is shown as a bared coupler, however additional couplers may be contemplated, including static couplers such as a snap coupler, slide coupler, twist coupler, quick release coupler, compression coupler, fitted coupler, or a spring-loaded coupler and the like.

The extended arm (14) of the invention may include a catch (16) configured to secure a display, and preferably a display cord (30). In the preferred embodiment shown in FIG. 3A-B, the catch (16) of the invention may include catch opening (17) which may include a horizontal gap configured to receive a display cord (3) in a lengthwise-fashion. As further shown in FIG. 3B, the internal portion of the catch may include a catch channel (18). In this preferred embodiment, the catch channel (18) may be responsive to the catch opening (17) and may further include an angles portion such that a display cord (3) may be positioned past the channel angle (31) portion so as to be secured within the catch channel (18) and restricted from extending back through the catch opening (17) and becoming detached from the extended arm (14). To help prevent the unintended movement of the display cord (3) in a vertical or horizontal manner, the internal surface of the catch channel (18) may include a ridged surface (19).

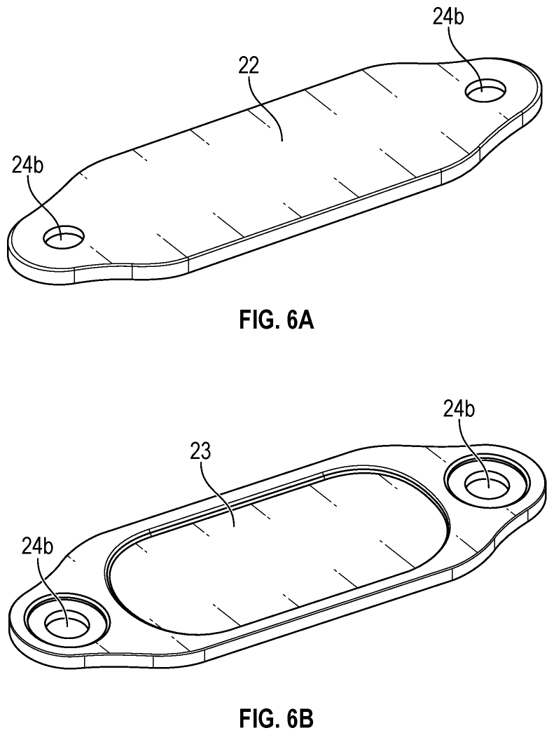

The display support system (1) of the invention may include an adaptor plate (20) configured to be secured to an external surface. In the preferred embodiment shown in FIG. 6A-B, an adaptor plate (20) may include a substantially planar component configured to be secured to an external surface. Notably, the planar shape is not limiting, as a variety of shapes may be used that allow attachment to, or are design to conform to an external surface, such as a shaped external surface, such as a pole and the like. Referring again to FIG. 6A-B, in one embodiment the adaptor plate (20) of the invention may include an adhesive adaptor (22) which may have an external adhesive configured to secure the adaptor to an external surface. In one embodiment the adaptor plate (20) of the invention may include a magnetic adaptor (21) which may have an external or internally positioned magnet configured to secure the adaptor to an external metal surface. As also shown in FIG. 6A-B, in one embodiment the adaptor plate (20) of the invention may include one or more fastener position (24b) that can be used to attach the adaptor plate (20) to an external surface using a fastener (24a), such as a screw, bolt, nail or other fastener known in the art.

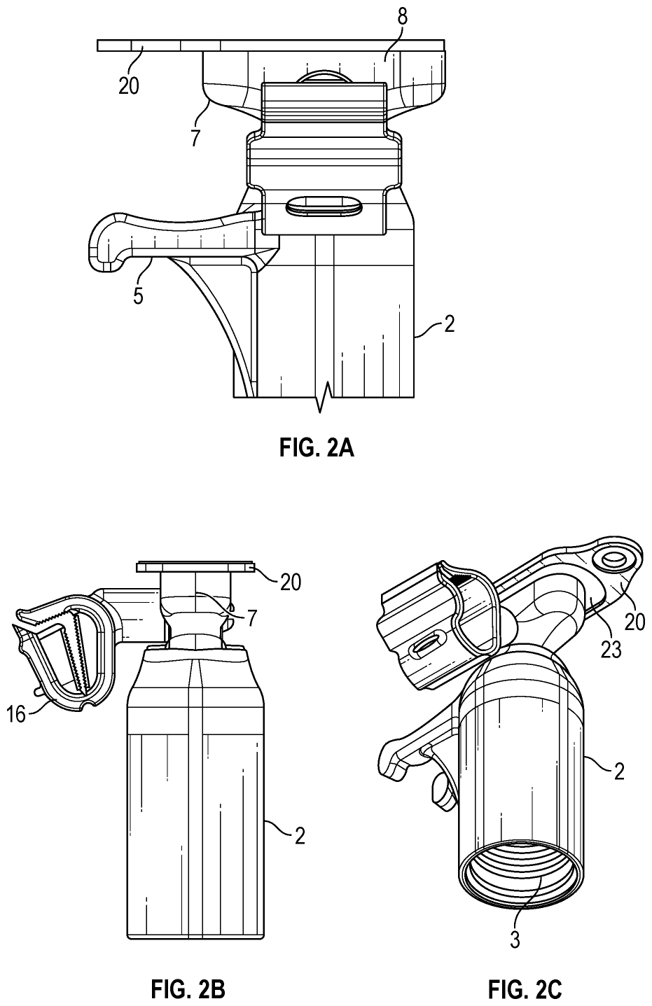

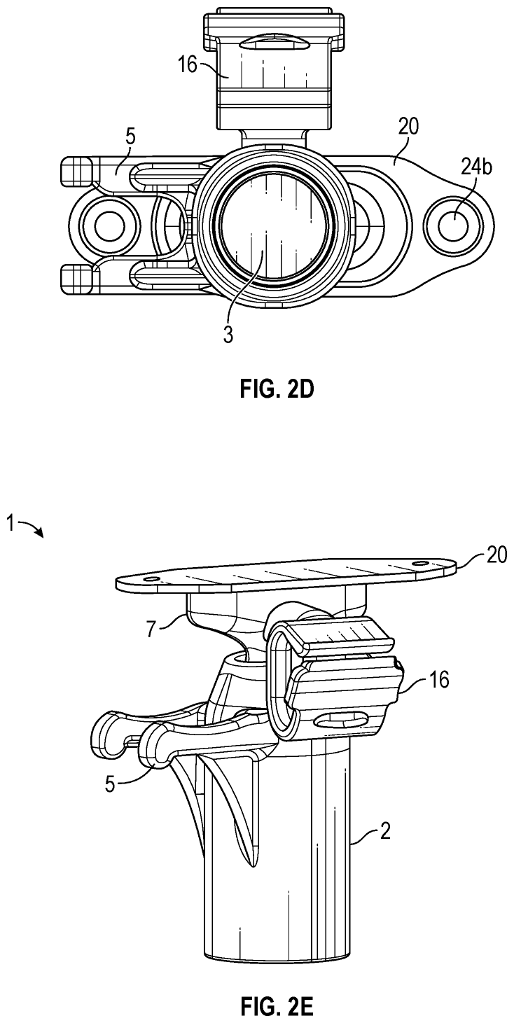

As shown in FIG. 6B, in one embodiment the adaptor plate (20) may include a pocket (23) what may be configured to be mated with the attachment surface (12) of the pivot support (7). As further shown in FIG. 2B, in a preferred embodiment the pocket of the adaptor plate (20) of the invention may be positioned over with attachment surface (12) of the pivot support (7). In some embodiment, this may include a fitted connection, or in other embodiment a magnetic or adhesive connection. In this configuration, an adaptor plate (20) may be elevated to an external position with the bottom side of the adaptor (20) being supported by the attachment surface (12) of the pivot support (7) which is further coupled with an installer (2) and pole (27). In this configuration, the top side of the adaptor (20) may be attached to an external surface, for example by adhering an adhesive layer to the top surface of the adaptor plate (20) or through a magnetic coupling with a metal external surface.

As generally shown in FIGS. 7-9, in one embodiment a display support system (1) of the invention may be used to support one or more external displays, and preferably an external lighting display (26). In one preferred embodiment, a user may attach an adaptor plate (20) to an external surface (25). This attachment, as noted above can include a magnetic coupling, an adhesive coupling or a coupling using one or more fasteners. Next, a user may optionally secure a pole (27) with the installer (2) of the invention. In a preferred embodiment, a pole (27) may be threadably coupled with the pole aperture (3) of the installer.

Next, the pivot support (7) may be coupled with the installer (2). In a preferred embodiment, the display insert (10) of the pivot support (7) may be inserted into the detachable coupler (4) of the installer (2). The display insert (10) and detachable coupler (4) may include one or more groove (28) and/or notch (29) that can be interlaced to prevent rotational movement of the installer (2) and pivot support (7) relative to one another. As noted above, a magnet (6) may be positioned within the detachable coupler (4) such that when it is secured to a pivot support (7) a corresponding metal coupler (9) is placed adjacent to the magnet (6) such that the two are responsive to one another and form a magnetic coupling securing the installer (2) and pivot support (7).

The extended arm (14) may next be coupled with the pivot support (7) of the invention. In a preferred embodiment, the rotational coupler (15) of the extended arm (14) may be inserted into the rotational slot (13) of the pivot support (7). A display cord (30) may be secured with the catch (16) of the extended arm (14), and preferably positioned past at the terminal portion of the catch channel (18) past the channel angle (31) portion as shown in FIG. 3B.

A user may next elevate the assembly securing a portion of the display cord (30) and secure the pivot support (7) with an adaptor plate (20) that has been attached to an external surface (25). In this configuration, the attachment surface (12) of the pivot support (7) may be coupled with the adaptor plate (20) through an adhesive or magnetic connection. In this embodiment, the force generating by the magnetic coupler formed by the magnet (6) and metal coupler (9) is weaker than the attachment force, generated by the magnetic or adhesive coupling of the attachment surface (12) to the adaptor plate (20). In this configuration, a user may retract the installer (2) such that the magnetic coupler formed by the magnet (6) and metal coupler (9) is broken while the magnetic or adhesive coupling of the attachment surface (12) to the adaptor plate (20) is maintained.

As shown in FIGS. 7-9, the steps described above may be repeated to position a plurality of pivot supports (7) securing one or more display or display cords (30) through an extended arm (14) to adaptor plates (20) secured to an external surface (25) in series or in parallel, or any configuration therewith. As noted herein, the adaptor plate (20) may be pre-secured to an external surface (25) prior to coupling the pivot support (7), while in separate embodiment, the adaptor plate (20) may be secured to an external surface (25) concurrently with the pivot support (7). As further noted herein, in certain embodiment, the attachment surface (12) of the pivot support (7) may be directly coupled with an external surface, for example through an adhesive or magnetic coupling.

Naturally, all embodiments discussed herein are merely illustrative and should not be construed to limit the scope of the inventive technology consistent with the broader inventive principles disclosed. As may be easily understood from the foregoing, the basic concepts of the present inventive technology may be embodied in a variety of ways. It generally involves systems, methods, techniques as well as devices to accomplish a improved display support system and the like. In this application, the methods and apparatus for the aforementioned systems are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the statements of invention. As can be easily understood from the foregoing, the basic concepts of the present invention may be embodied in a variety of ways. It involves both techniques as well as devices to accomplish the appropriate system. In this application, the techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention may be described in some instances in method-oriented terminology, each element of the claims corresponds to a device and vice versa. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon when drafting any claims. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “support” should be understood to encompass disclosure of the act of “supporting”—whether explicitly discussed or not—and, conversely, were there effectively disclosure of the act of “supporting”, such a disclosure should be understood to encompass disclosure of a “supporting method and/or technique, and/or device” and even a “means for supporting.” Such changes and alternative terms are to be understood to be explicitly included in the description.

Any patents, publications, or other references mentioned in this application for patent, such as in the specification or an IDS are hereby incorporated herein by reference in their entirety. Any priority case(s) claimed by this application is hereby appended and hereby incorporated herein by reference in their entirety. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated herein by reference in their entirety. Finally, all references listed in the list of References To Be Incorporated By Reference In Accordance With The Patent Application or other information disclosure statement and the like filed with the application are hereby appended and hereby incorporated herein by reference in their entirety, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the methods and/or apparatus for providing an improved display support system as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, xii) each potentially dependent claim or concept as a dependency on each and every one of the independent claims or concepts presented, and xiii) all inventions described herein.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. It should be understood that this application also provides support for any combination of elements in the claims and even incorporates any desired proper antecedent basis for certain claim combinations such as with combinations of method, apparatus, process, and the like claims.

Any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon. The inventive subject matter is to include, but certainly not be limited as, a system substantially as herein described with reference to any one or more of the Figures and Description (including the following: for example, the process according to any claims and further comprising any of the steps as shown in any Figures, separately, in any combination or permutation).

Finally, Applicant reserves the right to seek additional design patent protection over the claimed invention, such that the drawings are fully enabled so as to allow one of ordinary skill in the art to know that the claimed design was in Applicant's possession at the time of filing. As such, it should be noted that any broken lines are to be included for the purpose of illustrating environmental matter and form no part of the claimed design should such become necessary.

1. A display support system comprising:
an installer;
a pivot support having:
a support base;
an attachment surface;
a rotational slot;
a detachable coupler comprising a magnet and a metal coupler responsive to said magnet;
an extended arm having:
a rotational coupler securable to said rotational slot of said support base;
a latch;
an adaptor plate securable to an external surface and be coupled with said pivot support; and
a display.

2-35. (canceled)

36. A display support comprising:
an installer;
a pivot support securable to an external surface having:
a support base;
an magnetic or adhesive attachment surface;
a rotational slot;
a detachable coupler comprising a magnet and a metal coupler responsive to said magnet;
an extended arm having:
a rotational coupler securable to said rotational slot of said support base; and
a latch.

37. The device of claim 36, further comprising a pole aperture on said installer.

38. (canceled)

39. The device of claim 36, wherein said pivot support is coupled with said installer through said detachable coupler.

40. The device of claim 36, wherein said magnet is secured by said installer and said metal coupler is secured with said pivot support.

41. The device of claim 36, wherein said magnet and said metal coupler are positioned adjacent to one another forming a magnetic coupling when said installer and said pivot support are coupled together.

42. The device of claim 36, wherein said magnet and said metal coupler are positioned adjacent to one another within said detachable coupler forming a magnetic coupling when said installer and said pivot support are coupled together.

43. The device of claim 36, further comprising a latch on said installer that engages a channel on said support base of said pivot support.

44. The device of claim 43, further comprising a display insert on said support base of said pivot support insertable into said detachable coupler.

45. The device of claim 44, wherein said detachable coupler and said display insert each have one or a plurality of corresponding grooves and notches.

46. The device of claim 36, wherein said attachment surface comprises a magnetized attachment surface.

47. The device of claim 36, wherein said catch includes a catch opening to receive a display cord.

48. The device of claim 47, wherein said wherein said catch includes a catch channel configured to secure the display cord.

49. (canceled)

50. The device of claim 36, wherein said attachment surface is secured to an external surface by a magnet or an adhesive, and wherein said securement is stronger than said magnetic coupler.

51. The device of claim 36, wherein said display comprises a display selected from the group consisting of: an advertising display, a lighting display, a rope, display cord, a sign, a banner, a flag, and a balloon display, or a combination of the same.

52. A method of supporting a display comprising the steps:
securing a pole to an installer;
coupling said installer with a pivot support through a detachable coupler;
coupling an extended arm with said pivot support;
positioning a display cord in a catch of said extended arm;
securing said pivot support to an external surface; and retracting the installer coupled with said pivot support holding said display cord such that said pivot support is secured to said external surface.

53. The method of claim 52, and further comprising repeating steps 2-6 of claim 1 to secure a plurality of said pivot supports holding one, or a plurality of display cords, to an external surface.

54. The method of any of claims 52- 53, and further comprising the step of detaching said pivot support from said external surface.

55. The method of claim 52, and further comprising the step of engaging a latch on said installer with said pivot support and detaching said pivot support from said external surface.

56. The method of claim 55, wherein said step of engaging comprises the step of engaging a latch on said installer with a channel on said pivot support and detaching said pivot support from said external surface.

57. The method of claim 52, wherein said step of retracting comprises the step of disengaging said detachable coupler.

58. The method of claim 57, wherein said step of disengaging said detachable coupler comprises the step of disengaging magnetic coupler

59. The method of claim 52, wherein said step of securing said pivot support comprises the step of securing said pivot support to an external surface, or attaching a magnetic or adhesive surface attachment to said external surface

60. The method of claim 52, wherein said pivot support is weighted such that it maintains a substantially vertical position.

61. The method of claim 52, wherein said display cord comprise a lighting display cord.

62. The method of claim 52, wherein said step of positioning a display cord in a catch of said extended arm comprises the step of positioning a display cord in a catch channel of said extended arm.

63. The method of claim 62, wherein said catch channel comprises ridged catch channel.

64. The method of claim 52, w herein said step coupling an extended arm with said pivot support comprises the step of coupling an extended arm with said pivot support with a rotational coupler.

65. The device of claim 36, further comprising an adaptor plate secured to an external surface and coupled with said pivot support.

66. The system of claim 66, wherein said adaptor plate is selected from: a magnetic adaptor, an adhesive adaptor, an adaptor plate having a pocket securable to said attachment surface, and adaptor plate having one or more fastener positions to receive a fastener.

67. A display support comprising:
an installer;
a pivot support adapted to be secured to an external surface having:
a support base;
an magnetic or adhesive attachment surface;
a rotational slot;
a detachable coupler;
an extended arm having:
a rotational coupler configured to be secured to said rotational slot of said support base; and
a latch.

68. The display support of claim 67, wherein said detachable coupler comprises a magnet and a metal coupler responsive to said magnet.

69. The device of claim 67, further comprising an adaptor plate secured to an external surface and coupled with said pivot support.
